(19) United States
(12) Patent Application Publication
(10) Pub. No.: US 2016/0014448 A1
(43) Pub. Date: Jan. 14, 2016

(54) Communication Interface System and Method

(71) Applicant: MYE Entertainment, Inc., Stevenson Ranch, CA (US)

(72) Inventors: Anthony E. Garcia, Stevenson Ranch, CA (US); Ronald G. Pace, Naperville, IL (US)

(73) Assignee: MYE Entertainment, Inc., Stevenson Ranch, CA (US)

(21) Appl. No.: 14/796,823

(22) Filed: Jul. 10, 2015

Related U.S. Application Data
(60) Provisional application No. 62/022,703, filed on Jul. 10, 2014.

(51) Int. Cl. H04N 21/436; H04N 21/443; H04N 21/482; H04N 21/422; H04N 21/485

(52) U.S. Cl. CPC H04N 21/436; H04N 21/42207; H04N 21/42212; H04N 21/4221; H04N 21/4852; H04N 21/482; H04N 21/4432

(57) ABSTRACT

An interface system for facilitating the communication between a fitness device having a television system and a cable/satellite set top box is provided, wherein the interface system includes a first interface article and a second interface article. The first interface article is in signal communication with the television system and the second interface article is in signal communication with the first interface article and the cable/satellite set top box. The first interface article is configured to receive television control signals from the television system, identify channel control signals having Remote Control (RC) codes from the television control signals and transmit the channel control signals to the second interface article and wherein the second interface article is configured to identify the RC codes from the channel control signals, generate a processed signal containing the RC codes and transmit the processed signal to the cable/satellite set top box.

### CROSS REFERENCE TO RELATED APPLICATIONS

This application is related to and claims the benefit of the filing date of U.S. Provisional Patent Application Ser. No. 62/022,703 filed Jul. 10, 2014, the contents of which are incorporated herein by reference in its entirety.

### FIELD OF THE INVENTION

The present invention relates generally to fitness equipment and more particularly to an article and method for facilitating the communication between a cable/satellite box and a television on a fitness device.

### BACKGROUND OF THE INVENTION

It was very common in the fitness industry to have televisions located in various locations throughout the facility for members to watch during their workout routine. This helped to increase the enjoyment of exercising by reducing the boredom and monotony that many people experience while they are working out. Typically, each of these televisions was connected to a cable/satellite input (or Set-Top) box via a coaxial cable which brings the cable/satellite television channels to the television. Currently, a large number of exercise devices now come equipped with, or are retrofitted with, a television system that is capable of connecting directly with the cable/satellite input box. As such, these cable/satellite input boxes can be directly connected with a particular exercise device without requiring a set-top device or cable converter. This has proven to be an efficient and convenient way to control the television system because each television system typically has a built-in “cable ready” tuner and volume control.

Unfortunately however, cable and satellite companies have recently changed their configuration so that the cable/satellite channels are changed at the cable/satellite input box requiring the channels to be changed using a remote control device specific to that cable/satellite input box. As such, each of these television systems needs its own cable/satellite input box with its own remote control device to control the television channels. Essentially, the cable/satellite input boxes are configured such that, in order to view the cable/satellite channels, the television must be set to one specific channel. Thus, although the cable/satellite channels are changing based on the desires of the user, the channel on the television on which the viewer watches the cable/satellite channel remains fixed.

This type of configuration is undesirable because it prevents the fitness clubs from using one cable/satellite input box. Typically, fitness clubs would have one cable/satellite input box for several televisions. The clubs would ‘split’ the cable/satellite signal and direct the split signals to several different television systems. Because the television systems were ‘cable ready’, when a user changed the channel on the television system, the corresponding cable/satellite channel would be displayed. The new configuration, however, prevents the channels on the television system from being used. Another reason this configuration is undesirable is that the channel up/down controls are now being controlled by a handheld remote control device that is specific to and communicates only with a particular cable/satellite input box. However, the power and volume control for the television system is being controlled by separate switches which may be built into or added onto the fitness device. As such, multiple devices are now required to operate one television system. This is undesirable because the handheld remote is subject to being lost or broken and it will be confusing to the user because the user will not know when to use the handheld remote and the control on the exercise device.

### SUMMARY OF THE INVENTION

A communication interface system for facilitating the communication between a fitness device having a television system and a cable/satellite set top box is provided, wherein the interface system includes a first interface article and a second interface article. The first interface article is in signal communication with the television system and the second interface article is in signal communication with the first interface article and the cable/satellite set top box. The first interface article is configured to receive television control signals from the television system, identify channel control signals having Remote Control (RC) codes from the television control signals and transmit the channel control signals to the second interface article and wherein the second interface article is configured to identify the RC codes from the channel control signals, generate a processed signal containing the RC codes and transmit the processed signal to the cable/satellite set top box.

An interface system for facilitating the communication between a fitness device having a television system and a cable/satellite set top box is provided and includes a first interface article and a second interface article. The first interface article is in signal communication with the television system and the second interface article is in signal communication with the first interface article and the cable/satellite set top box. The first interface article is configured to receive television control signals from the television system, identify channel control signals having Remote Control (RC) codes from the television control signals and wirelessly transmit the channel control signals to the second interface article and the second interface article is configured to identify the RC codes from the channel control signals, generate a processed signal and transmit the processed signal to the cable/satellite set top box, wherein the processed signal is compatible with the cable/satellite set top box and includes at least one of the RC codes and an equivalent set of RC codes.

A communication interface system for facilitating the communication between a television system mounted externally to a fitness device and a cable/satellite set top box is provided and includes a first interface article, wherein the first interface article is in signal communication with at least one of the television system, the fitness device, a television control panel, and a keypad interface article. The communication interface system further includes a second interface article, wherein the second interface article is in signal communication with the first interface article and the cable/satellite set top box. The first interface article is configured to receive and process television control signals from at least one of the television system, the fitness device, the television control panel, and the keypad interface article, identify channel control signals having Remote Control (RC) codes from the television control signals and transmit the channel control signals to the second interface article, and the second interface article is configured to identify the RC codes from the channel control signals, generate a processed signal having the RC codes and being configured to operate with the cable set top box and transmit the processed signal to the cable/satellite set top box.

A communication interface system for facilitating the communication between a television system and a cable/satellite set top box is provided, wherein the communication interface system includes at least one interface article, wherein the at least one interface article is in signal communication with the television system and the cable/satellite set top box, wherein the at least one interface article is configured to receive television control signals, identify channel control signals having television Remote Control (RC) codes from the television control signals, communicate with a handheld remote control configured to communicate with the cable/satellite set top box to receive and store cable/satellite box Remote Control (RC) codes, generate a processed signal responsive to the television RC codes containing cable/satellite box RC codes compatible with the cable/satellite set top box and transmit the processed signal to the cable/satellite set top box.

A method for facilitating the communication between a cable/satellite set top box and at least one of a fitness device and a television system, wherein the television system includes a television monitor is provided, wherein the method includes receiving television control signals, wherein the television control signals include at least one of a volume control signal, a power control signal and a channel control signal, identifying whether the television control signals include at least one of the volume control signal, the power control signal and the channel control signal, wherein if the television control signals include the channel control signal, processing the channel control signal and transmitting a processed channel control signal to the cable/satellite set top box and if the television control signals include at least one of the volume control signal and the power control signal, processing the at least one of the volume control signal and the power control signal and transmitting the at least one of the volume control signal and the power control signal to the television system.

A communication interface system for facilitating the communication between a cable/satellite set top box and a fitness device having a television system is provided, wherein the communication interface system includes at least one interface article, wherein the at least one interface article is in signal communication with at least one of the television system, the fitness device, a television control panel, a keypad interface article and the cable/satellite set top box and wherein the at least one interface article is configured to receive and process television control signals from at least one of the television system, the fitness device, the television control panel, and the keypad interface article, identify channel control signals having television Remote Control (RC) codes from the television control signals, communicate with a handheld remote control configured to communicate with the cable/satellite set top box to receive and store cable/satellite box Remote Control (RC) codes, generate a processed signal having the cable/satellite box RC codes responsive to the television RC codes and being configured to operate with the cable set top box and transmit the processed signal to the cable/satellite set top box.

### BRIEF DESCRIPTION OF THE DRAWINGS

FIG. 1A is a block diagram showing components of a communication interface system having a first interface article and a second interface article, in accordance with one embodiment of the invention.

FIG. 1B is a block diagram of a cable/satellite input box and a fitness device having a television system and television control buttons integrated with the fitness device.

FIG. 2 is a block diagram showing components of a communication interface system having a first interface article, a second interface article and a keypad article, in accordance with another embodiment of the invention.

FIG. 3 is a block diagram of the communication interface system of FIG. 1A associated with the cable/satellite input box and the fitness device of FIG. 1B, having a television system and television control buttons, in accordance with an embodiment of the invention.

FIG. 4 is a front view of the television monitor of the television system of FIG. 1B having switches integrated with the television system.

FIG. 5A is a front view of the television monitor of the television system of FIG. 1B having soft or Touch Menu Item (TMI) switches integrated with the television screen.

FIG. 5B is a front view of a fitness device with the television monitor of FIG. 5A having soft or Touch Menu Item (TMI) switches integrated with the television screen.

FIG. 6 is a block diagram of the communication interface system of FIG. 2 associated with a cable/satellite input box and a fitness device having a television system without television control buttons integrated therein, in accordance with an embodiment of the invention.

FIG. 7 is an operational block diagram illustrating a method for controlling the communication between a cable/satellite input box and a television system on a fitness device via the communication interface system of FIG. 1A and FIG. 2, in accordance with one embodiment of the invention.

FIG. 8 is an operational block diagram illustrating a method for programming the second interface article to operate with a specific cable/satellite input box, in accordance with one embodiment of the invention.

### DETAILED DESCRIPTION OF THE INVENTION

In accordance with the present invention, a system and method for facilitating the communication between a television and a cable/satellite input box is provided and discussed herein with regards to a television system integrated with or installed onto a fitness device, such as a treadmill.

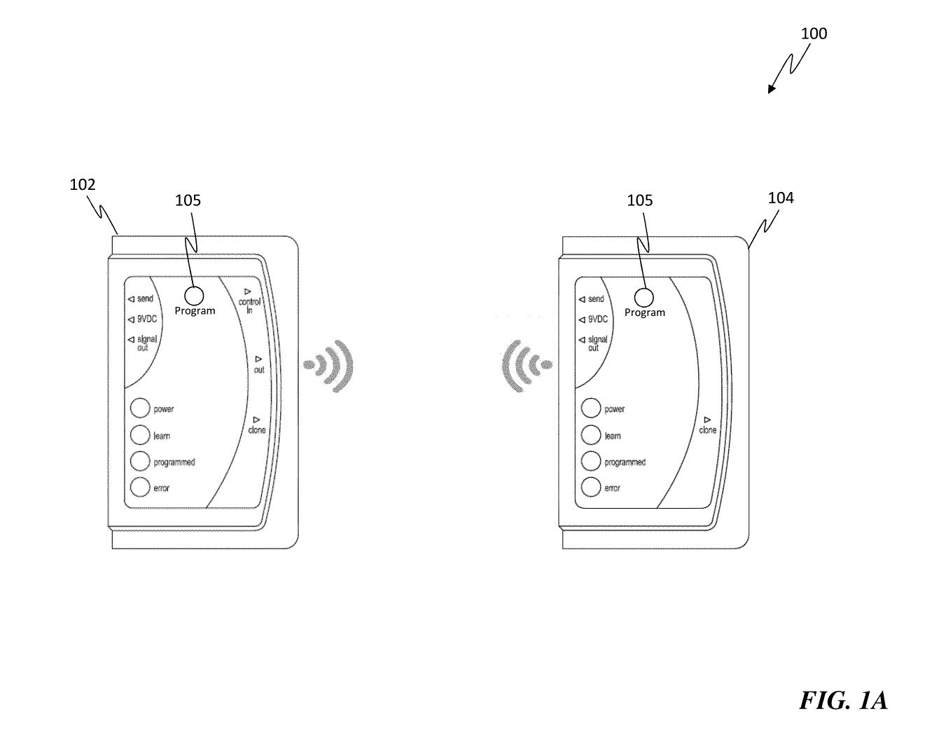

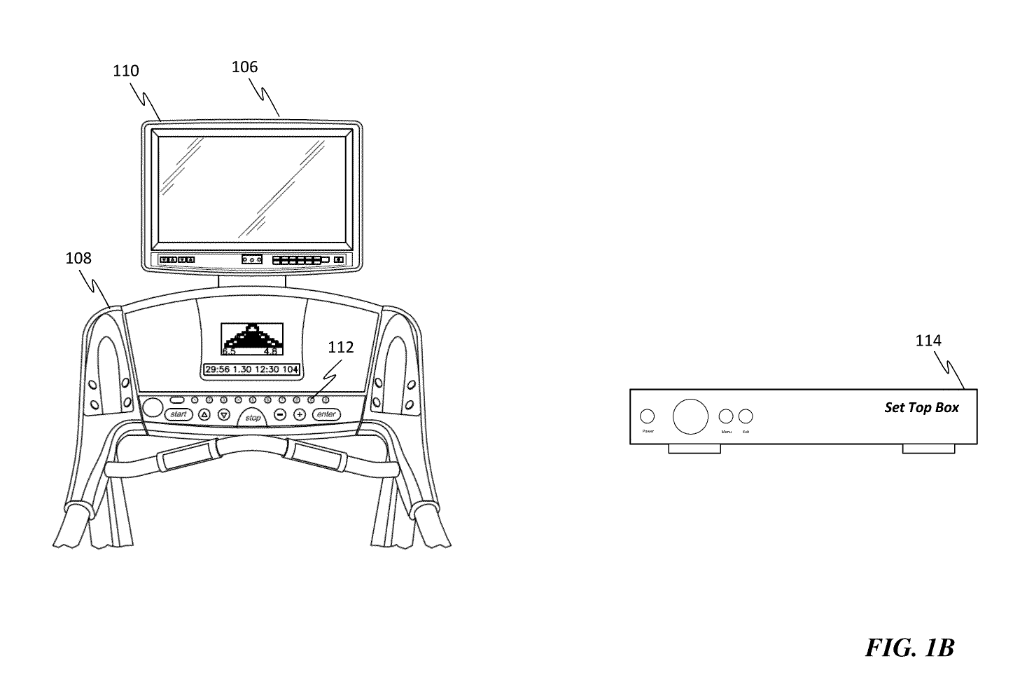

Referring to FIG. 1A, the present invention is a communication interface system 100 having a first interface article 102 and a second interface article 104, wherein the first interface article is configured to wirelessly communicate with the second interface article 104 and wherein the first and second interface articles 102, 104 include a power indicator LED, a learn indicator LED, a programmed indicator LED and an error indicator LED. Additionally, the first and second interface articles 102, 104 may include various input/output ports for hardwire connection to external components such as an input power source, a television system and/or a cable/satellite input box. It should be appreciated that the second interface device 104 may communicate with the cable/satellite input box via any method suitable to the desired end purpose, such as via a hardwire connection, via a wireless connection such as via an IR transmitter on the second interface device 104 and/or via a wireless connection such as via an RF transmitter on the second interface device 104 and an RF receiver on the cable/satellite input box.

Referring to FIG. 1B, the first interface article 102 (see FIG. 1A) is further configured to associate with a television system 106 that is integrated with, or added onto (retrofit), a fitness device 108, wherein the television system 106 includes a television monitor 110 and a television control interface 112 having one or more television control buttons/switches (soft and/or hard). For example, some fitness devices 108 already include a television system 106 while other fitness devices 108 are configured so that a television system can be retrofitted if desired. The latter fitness devices 108 may include television control buttons 112 that can be used if a television system 106 is retrofitted. The television control buttons 112 may include a power on/off button, volume command buttons and/or channel command buttons. The first interface article 102 is configured to receive the channel command signal, power on/off signal and the volume command signal from the television control buttons 112 and transmit the channel command signal to the second interface article 104. The second interface article 104 includes a program button (PB) 105 which puts the second interface article 104 into a “learning mode” which allows the second interface article 104 to be programmed to operate with a specific cable/satellite input box 114 as discussed further herein.

It is contemplated that in additional embodiments the first interface article 102 may include the program button (PB) 105 to put the first interface article 102 into a “learning mode” to allow the first interface article 102 to be programmed to operate with a specific cable/satellite input box 114.

The second interface article 104 is further associated (either wirelessly and/or via a hardwire connection) with the cable/satellite input box 114 and is configured to receive the channel command signal from the first interface article 102. The second interface article 104 processes the channel command signal received from the first interface article 102 to generate a cable channel command signal which matches the signal protocol of the cable/satellite input box 114 and communicate the cable channel command signal to the cable/satellite input box 114 such that the channel on the cable/satellite input box 114 changes as desired. Additionally, the first interface article 102 is also configured to receive the power on/off signal and the volume command signal from the television control buttons 112 and transmit (or pass through) the volume command signal and/or the power on/off signal to the television system 106 to cause the television system 106 to be powered on/off and/or the volume to be increased/decreased.

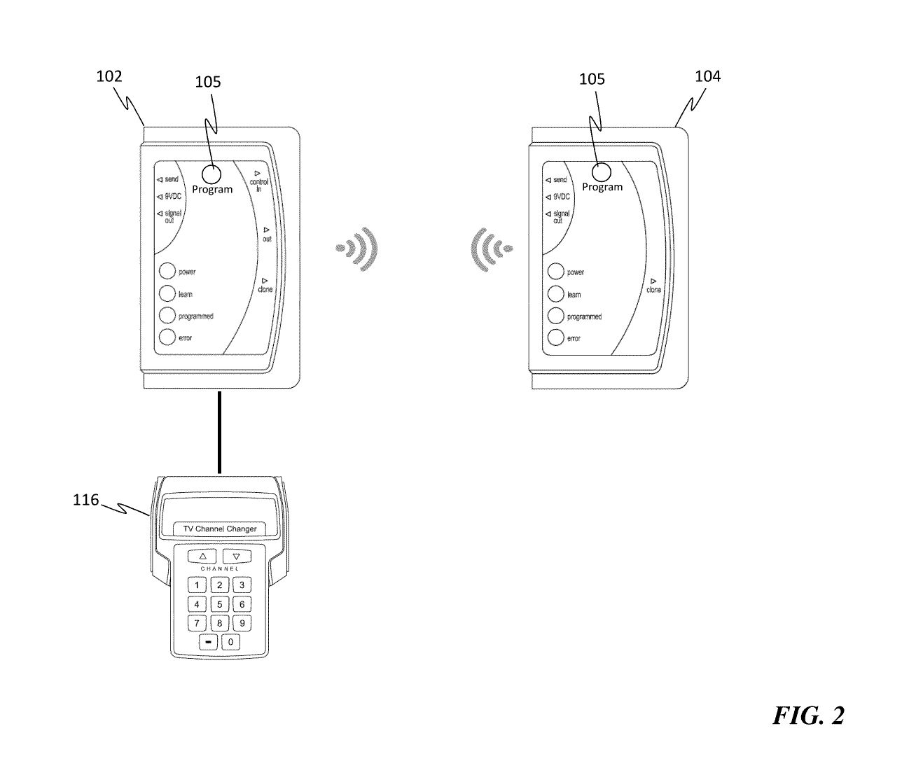

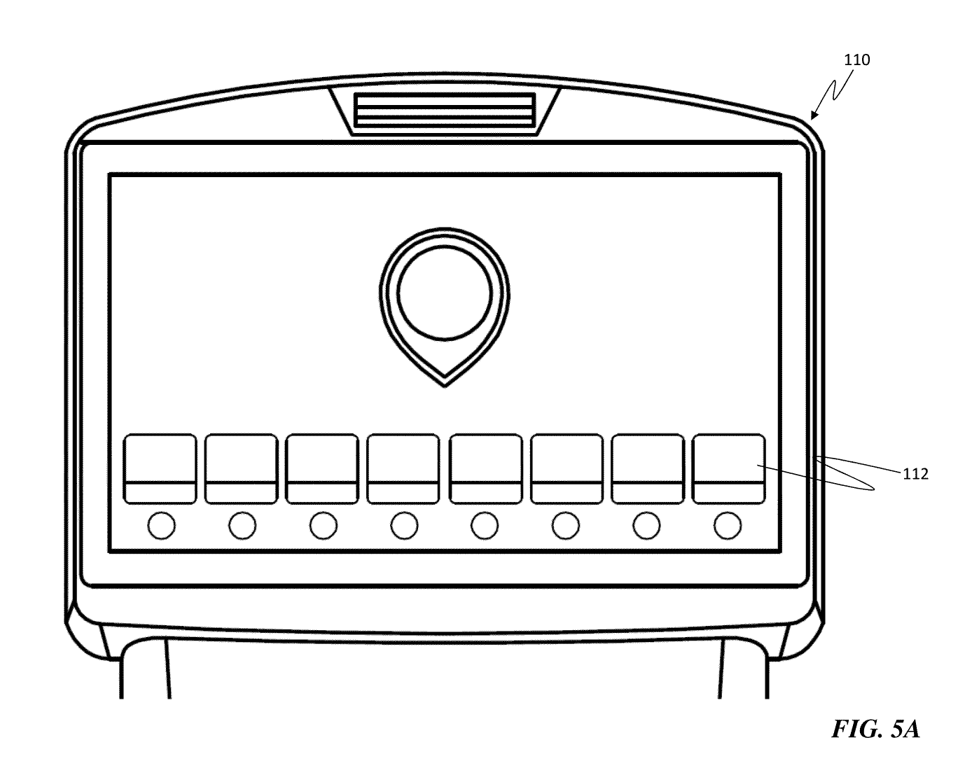

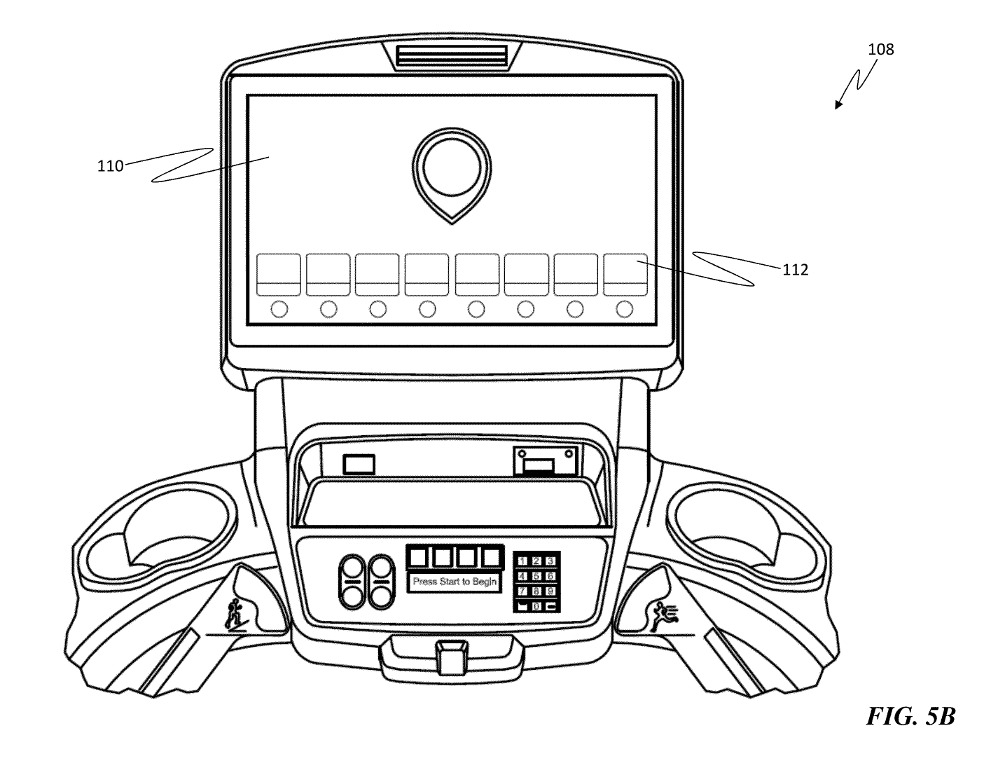

It should be appreciated that not all fitness devices 108 are configured to include television control buttons 112. Thus, in the situation where a television system 106 is retrofitted to a fitness device 108 that does not have integrated television control buttons, the present invention may further include a keypad interface 116. Referring to FIG. 2, the keypad interface 116 is provided and may be securely associated with the fitness device 108 such that a user may have easy access and use (See FIG. 5). The keypad interface 116 may be configured to include television control buttons 112, including channel command buttons, volume command buttons and/or a power on/off button. The keypad interface 116 is in signal communication (via a hard wired or wireless connection) with the first interface article 102 which is configured as discussed hereinabove. When a user wants to change the channel, change the volume and/or turn on/off the television system 106, the user presses the appropriate command button on the keypad interface 116. The appropriate signal is communicated to the first interface article 102 which sends the appropriate command to either the television system 106 and/or the cable/satellite input box 114. Furthermore, it is contemplated that in another embodiment, the keypad interface 116 may be integrated with the first interface article 102.

It should be appreciated that the first interface article 102 receives the television control signals from the keypad interface 116 and/or television control buttons 112, such as the channel command signal, volume command signal and/or power on/off signal. This communication between the first interface article 102, the television monitor 110, the keypad interface 116 and/or the television control buttons 112 may be accomplished via any method or device suitable to the desired end purpose, such as for example Infrared (IR) (modulated or unmodulated) communication, asynchronous serial communication, and/or any other serial communication. The first interface article 102 decodes the television control signals from the keypad interface 116 and/or television control buttons 112 and all commands related to the television system 108, i.e. volume control, mute, Closed Caption (CC), aspect ratio, power on/off, etc. are reformatted into a serial protocol that is acceptable to the television system 106 and passed to the television system 106.

All cable/satellite commands related to the cable/satellite input box 114 (Set Top Box) are transmitted wirelessly to the second interface article 104. The second interface device 104 then processes the cable/satellite commands to generate processed cable/satellite commands which are compatible with the cable/satellite input box 114. The second interface device 104 then sends the processed cable/satellite commands to the cable/satellite input box 114 which causes the cable/satellite input box 114 to operate responsive to the processed cable/satellite commands. This communication between the second interface article 104 and the cable/satellite input box 114 may be accomplished via a hardwired connection, wireless connection (such as for example IR), wired IR communication, etc. Moreover, the second interface article 104 may be configured to communicate with the handheld remote control 113 device that came with the cable/satellite input box 114 and may be accomplished via a wireless connection, such as for example via an IR communication, RF communication, etc. It should be appreciated that the second interface article 104 may have the IR codes of the cable/satellite input box 114 embedded into memory (such as FLASH) for each unique cable/satellite input box 114 brand and model.

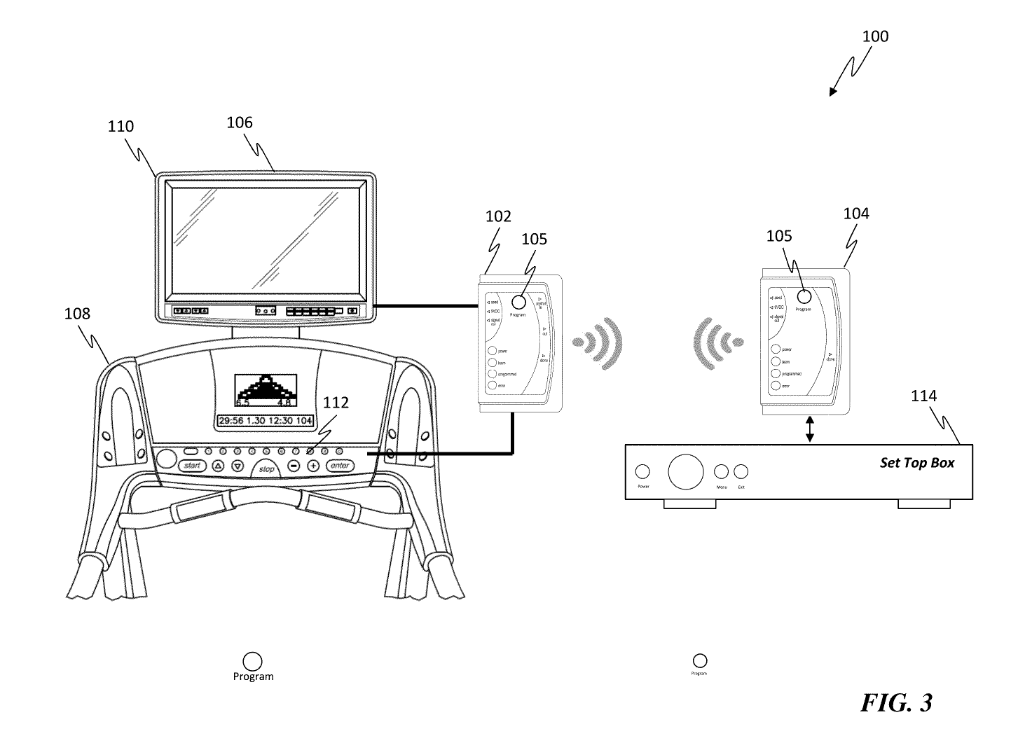

Referring to FIG. 3 a communication interface system 100 associated with a fitness device 108 having a television system 106 that is connected to a cable/satellite input box 114 which receives a cable/satellite signal from an outside connection is shown in accordance with a first embodiment. The fitness device 108 may be any type of fitness device 108 suitable to the desired end purpose and may include a television monitor 110 and television control switches/buttons 112. The communication interface system 100 includes the first interface article 102 and the second interface article 104, wherein the first interface article 102 may be communicated with the second interface article 104 via a wireless connection as discussed hereinabove. Moreover, the first interface article 102 is associated with the fitness device 108 to be electrically connected to the television monitor 110 and the television control switches/buttons 112 and the second interface article 104 is associated with cable/satellite input box 114 to control the satellite/cable channel control function. The cable/satellite signal may be communicated from the cable/satellite input box 114 to the television system 106 via any device and/or method suitable to the desired end purpose, such as a wireless connection and/or a hardwired connection. It should be appreciated that as referred to herein, a fitness device 116 may be any fitness device suitable to the desired end purpose, such as a treadmill, a bike, an elliptical, a rower, a spin bike, a stepper machine, a stair climbing machine, a strength training machine, etc.

It should be appreciated that the first interface article 102 is communicated with the second interface article 104 via a wireless connection, in accordance with the invention. The first interface article 102 is electrically connected to the television system 108 (television control switches/buttons 112 and/or television monitor 110) of the fitness device 108 (via hardwired circuitry and/or other device/method such as wireless connection) to receive the power on/off signal, volume up/down/mute signal and the channel control signal from the television control switches/buttons 112 of the exercise device 108. The first interface article 102 transmits the channel control signal to the second interface article 104 which identifies and filters out the Remote Control (RC) codes from the channel control signal, generates an equivalent set of RC codes that is compatible with the cable/satellite input box 114 and communicates the equivalent set of RC codes to the cable/satellite input box 114 which causes the cable channel on the cable/satellite input box 114 (and therefore on the television monitor 110) to increase or decrease as desired. It is contemplated that in other embodiments, an equivalent set of RC codes may not be generated and the filtered out RC codes may be used and passed through to the cable/satellite input (set top) box 114.

When other types of signals, such as the power on/off signal and the volume control signal, are received by the first interface article 102 from the television control switches/buttons 112 of the exercise device 108 (and/or a TV display keypad interface, and/or a standalone keypad interface), the first interface article 102 communicates these signals directly to the television monitor 110. This may be accomplished by converting the power control (on/off) signals and the volume control (up/down/mute) signals into a communication protocol acceptable by the television monitor and communicating the power control (on/off) signals and the volume control (up/down/mute) signals to the television monitor 110 and/or simply passing the power control (on/off) signals and the volume control (up/down/mute) signals through to the television monitor. Accordingly, when a user wants to change the channel, change the volume and/or turn on/off the television system 106, the user presses the appropriate command button on the television control switches/buttons 112 of the exercise device 108 (or other devices that may have a television control interface). The appropriate signal is communicated to the first interface article 102 which sends the appropriate command to either the television system 106 and/or the second interface article 104. When the second interface article 104 receives the channel command signal, the second interface article 104 filters out the Remote Control (RC) codes from the channel control signal, generates an equivalent set of RC codes and communicates the equivalent set of RC codes to the cable/satellite input box 114.

It should be appreciated that although the first interface article 102 and the second interface article 104 communicate with each other via an RF wireless connection, it is contemplated that the first interface article 102 and the second interface article 104 are not limited to the RF spectrum and may communicate with each other via any device and or method suitable to the desired end purpose. In accordance with the present invention, this advantageously allows for communication between a television system 106 on a fitness device 108 and the cable/satellite input box 114. Additionally, although the present invention is discussed herein as the filtering and generating of equivalent RC codes being conducted via the second interface article 104, the filtering and/or generating of equivalent RC codes may be conducted by the first interface article 102 or both the first and second interface articles 102, 104.

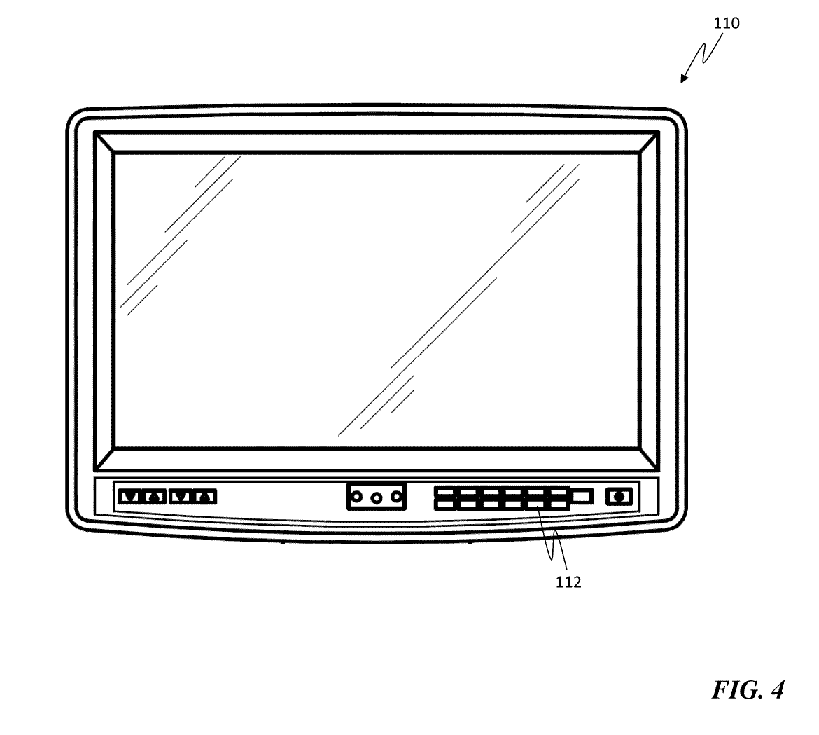

Referring to FIG. 4, FIG. 5A and FIG. 5B, it should be appreciated that the television control switches/buttons 112 may be integrated with the television monitor 110 as membrane buttons or embedded as soft Touch Menu Item (TMI) switches or touch screen buttons via the television display interface. In this case, the television system 108 and the television control switches/buttons 112 may be integrated into the same display that is used to display the exercise progress of the user. Additionally, the first interface article 102 may be electrically connected to the television monitor 110 to be connected with the television control switches/buttons 112, wherein the first interface article 102 may be fully or partially integrated into either the fitness device 106, the television system 108 and/or the television monitor 110. Accordingly, the first interface article 102 may receive the channel control signal from the television monitor 110 and communicate those channel control signals to the second interface article 104 which will then filter out the Remote Control (RC) codes from the channel control signal, generate an equivalent set of RC codes and communicate the equivalent set of RC codes to the cable/satellite input box 114. It is also contemplated that the first interface article 102 may or may not be integrated with the television system 106.

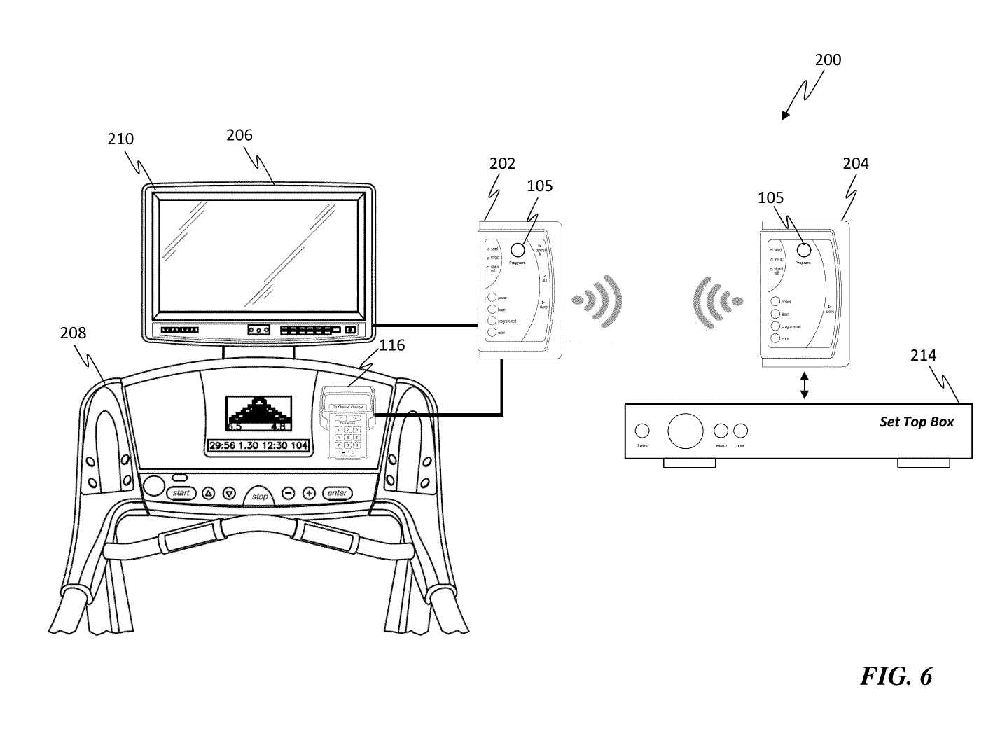

Referring to FIG. 6, a communication interface system 200 associated with a fitness device 208 is shown, wherein the fitness device 208 includes a television system 206 that is connected to a cable/satellite input box 214 which receives a cable/satellite signal from an outside connection is shown in accordance with a second embodiment. In this instance, the fitness device 208 includes a retrofitted television system 206 having a television monitor 210. However, the fitness device 208 does not include television control switches/buttons. Accordingly, the communication interface system 200 includes a first interface article 202, a second interface article 204 and a keypad interface 116, wherein the keypad interface 116 is communicated with the first interface article 202 and includes television control switches/buttons 212. Additionally, the first interface article 202 is further communicated with the second interface article 204 via a wireless connection as discussed hereinabove. Moreover, the first interface article 202 is associated with the fitness device 208 to be electrically connected to the television monitor 210 and the second interface article 204 is associated with cable/satellite input box 214 to control the satellite/cable channel control function. The cable/satellite signal is communicated from the cable/satellite input box 214 to the television monitor 210 via a hardwired connection.

As discussed hereinabove, when a user wants to change the channel, change the volume and/or turn on/off the television system 206, the user presses the appropriate command button on the keypad interface 116. The appropriate signal is communicated to the first interface article 202 which sends the appropriate command to either the television system 206 and/or second interface article 204. When the second interface article 204 receives the channel command signal, the second interface article 204 filters out the Remote Control (RC) codes from the channel control signal, generates an equivalent set of RC codes and communicates the equivalent set of RC codes to the cable/satellite input box 214.

In accordance with one embodiment of the invention, the action commands are coming from the television control switches/buttons 112 and/or keypad interface 116, in at least one of an un-modulated IR format, a modulated IR format or an asynchronous serial format. The first interface article 102, 202, receives and decodes the incoming action commands to identify volume control commands, power commands and/or channel control commands. The first interface article 102, 202 then decides if the commands need to be passed through to the television system 108, 208 or be sent to the remote cable/satellite input box 214 via the wireless connection with the second interface article 104, 204. If the action commands are volume control commands and/or power commands, then they are transmitted to the television system 108, 208. If the action commands are channel control commands, then they are transmitted to the second interface article 104, 204. It should be appreciated that if the action commands need to be passed through to the television system 108, 208, then the first interface article 102, 202 may encode the commands into a format compatible with the television system 108, 208 and transmit the action commands to the television system 108, 208 (such as via a wireless communication and/or via a pass-through port located on the interface article 102, 202 which is connected to the television system 108, 208).

If the action commands (i.e. channel control commands) need to be passed through to the remote cable/satellite input box 214, then the actual codes are sent to the second interface article 104, 204 via a wireless (or hardwired) connection. The second interface article 104, 204 may then process the action commands to encode the action commands in a format compatible with the remote cable/satellite input box 214 and send the processed commands to the remote cable/satellite input box 214. This may be accomplished via an IR emitter (modulated), via an unmodulated IR hard wired connection (such as a 3.5 mm cable) and/or via a wireless connection. Additionally, it is contemplated that the action commands may be encoded as desired.

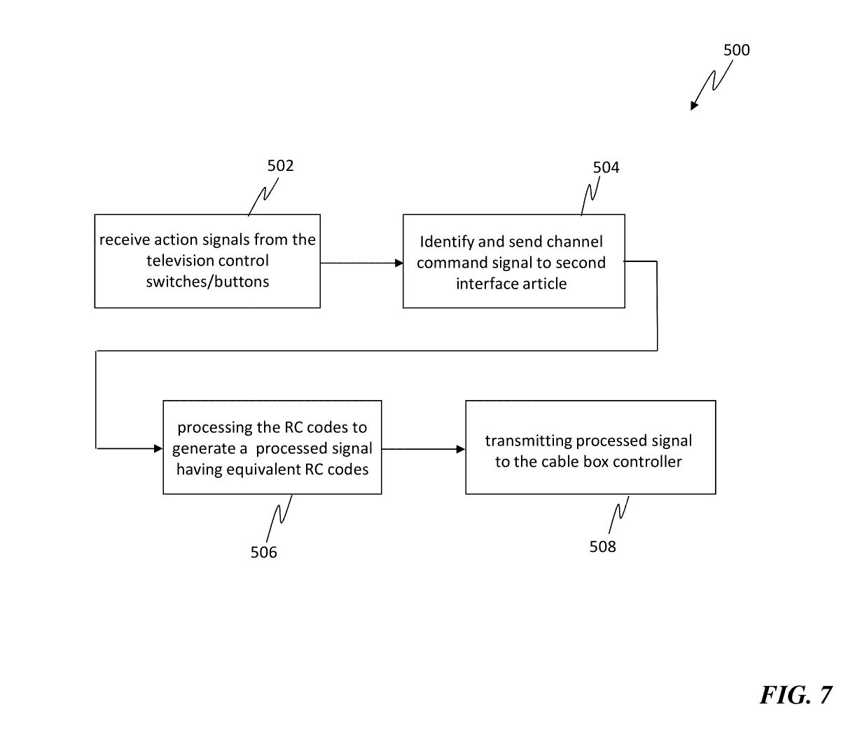

Referring to FIG. 7, an operational block diagram illustrating a method 500 for controlling the communication between a cable/satellite input box 114, 214 and a television system 106, 206 on a fitness device 108, 208 via a communication system 100, 200 having a first interface article 102, 202 and a second interface article 104, 204 is illustrated, in accordance with one embodiment of the invention. The method 500 includes receiving action signals via the first interface article 102, 202 from the television control switches/buttons 212, as shown in operational block 502. The action signals (may include power on/off, volume up/down/mute, channel up/down and/or a channel numerical designator) are generated by actuating one of the television control switches/buttons 212 located on the fitness device 108, 208, television system 106, 206 or the keypad interface 116 to turn the power on/off, turn the volume up or down and/or to change the channel. When the first interface article 102, 202 receives an action signal from the television control switches/buttons 212, the first interface article 102, 202 transmits the channel command signal (if present) to the second interface article 104, 204. The second interface article 104, 204 processes the channel command signal to identify and filter out the RC codes, as shown in operational block 504, and then processes the RC codes to generate a processed signal having equivalent RC codes (or RC codes that are compatible with the cable/satellite input box 114, 214), wherein the processed signal is formatted to communicate with the cable/satellite input box 114, 214, as shown in operational block 506. It should be appreciated that if the channel command signal is already in a format compatible with the cable/satellite input box 114, 214, then the channel command signal may just be passed through to the cable/satellite input box 114, 214 without any (or with very little) processing. The second interface article 104, 204 then transmits the equivalent RC codes to the cable/satellite input box 114, 214, as shown in operational block 508, to cause the cable/satellite input box 114, 214 to increase or decrease the cable channel.

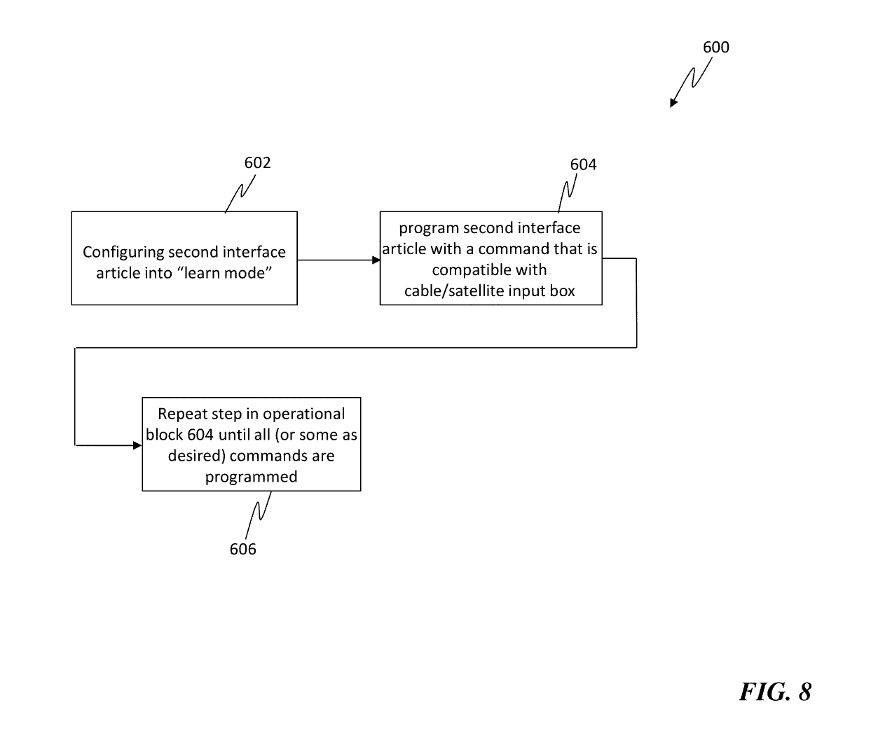

It should be further appreciated that, in at least one embodiment, the second interface article 104, 204 needs to be ‘set up’ to work with a specific cable/satellite input box 114, 214 and thus, needs to be put into a “learning mode.” Referring to FIG. 8, an operational block diagram illustrating a method 600 for programming the second interface article 104, 204 to operate with a specific cable/satellite input box 114, 214 is illustrated, in accordance with one embodiment of the invention. The method 600 includes putting the second interface article 104, 204 into the “learn mode,” as shown in operational block 602. This may be accomplished by powering on the second interface article 104, 204 and simultaneously activating/depressing the PB switch 105 for a predefined period of time, such as for example approximately about 2 seconds. After the predefined period of time, the PB switch 105 is released and the second interface article 104, 204 is in “learn mode.” The second interface article 104, 204 is then programmed with a command that is compatible with the cable/satellite input box 114, 214, as shown in operational block 604. This may be accomplished by pointing the handheld Set Top Box (STB) remote control device that came with the cable/satellite input box 114, 214 towards (aligned via line of sight) the cable/satellite input box 114, 214. The “0” button on the handheld STB remote control is depressed until the “PROG” LED indicator on the second interface article 104, 204 flashes on and off. The “0” button on the handheld STB remote control is depressed again until the “LEARN” LED indicator on the second interface article 104, 204 flashes on and off. At this point the “0” command has been programmed into the second interface article 104, 204. This process is then repeated for “1”, “2”, “3”, “4”, “5”, “6”, “7”, “8”, “9”, “−”, “Channel Up” and “Channel Down”, as shown in operational block 606. When all of the cable commands have been programmed, the LED indicators on the second interface article 104, 204 will flash on and off. At this point, the second interface article 104, 204 will go into listen (normal use) mode. It should be appreciated that the method disclosed herein is not limited to any particular sequence and may be conducted in any sequence suitable to the desired end purpose.

It should be appreciated that since all cable boxes have different RC codes for channel command signals, the second interface article 104, 204 (and/or first interface article 102, 202) device may advantageously have the ability to learn and store these RC codes into a non-volatile memory through a built-in IR receiver sensor. Moreover, as each RC connecting pair (first and second interface articles 102, 202, 104, 204) may have its own unique address and can operate within the confines and environment of a large health club or another large facility. This approach advantageously solves all the problems discussed hereinabove and the communication system 100, 200 is extremely versatile as the cable/satellite input box 114, 214 can be located anywhere within the facility and the performance is stable, immediate and seamless to the end user. Additionally, the first and/or second interface articles 102, 202, 104, 204 are configurable to work with all cable company services and their equipment as well as being reprogrammable to accommodate future changes in cable equipment and services. Moreover, it is contemplated that in at least one embodiment, the first interface article 102, 202 and/or second interface article 104, 204 may be remotely accessible and/or controllable via a wireless interface. For example, a wireless control interface may be used to access a specific first interface article 102, 202 to shut the television system 106, 206 down, to control the volume of the television system 106, 206 and/or to power a television system on or off. It should also be appreciated that the first interface article 102, 202, the second interface article 104, 204 and/or the keypad interface 116 may be ‘paired’ together.

It is contemplated that in other embodiments, the first interface article 102, 202 and/or second interface article 104, 204 may be remotely controllable (and/or programmable) to control which television channels are shown on a specific television system 106, 206 based on one or more factors. For example, a high tier member of a fitness club may have access to all of the available channels (include tutorial channels that teach proper workout technique) while a lower tier member or guest of a fitness club may be limited to only certain channels. In such a case, the communication system 100, 200 (and/or the television system 106, 206 and/or fitness device 108, 208) may be configured to communicate with a smartphone/mobile device (such as a PDA, iPhone, iPad, etc.) via a wireless and/or a hardwired connection to limit or restrict the channels that can be viewed and listened to based on member status, member age, membership type (premium or basic). As such, a member who has a premium membership may have a mobile device software application specific to their fitness club that will communicate with the communication system 100, 200 (and/or the television system 106, 206 and/or fitness device 108, 208) to ‘unlock’ the channels thus allowing them to view all available TV/content programming that is delivered either by the cable/satellite input box 114, 214 and/or a local and/or remote web server.

As such, the mobile device software application may communicate with the communication interface system 100, 200 (and/or the television system 106, 206 and/or fitness device 108, 208) to identify what viewing and/or listening channels are available to the specific user of the fitness device 108, 208. The communication system 100, 200 and/or television system 106, 206 would have software that would be able to control the channels that may be available for viewing. When a channel that is identified as being restricted is encountered, a message may be displayed to the user via the television monitor 110, such as “upgrade your membership to view” or “see front desk to view this channel”.

It should be appreciated that the first interface article 102, 202, second interface article 104, 204 and/or keypad interface 116 may be powered via an internal battery (5 VDC or greater), an internal and/or external power supply, the fitness device 108, 208 (for example, via a CSAFE port), via the television system 106, 206 and/or the cable/satellite input box 114, 214, or a cable that is plugged into an outlet that is in proximity to the device(s). It should be appreciated that the communication between one or more of the components of the present invention is preferably in the 900/800 MHz range. However, the communication between one or more of the components of the present invention is not limited to 900/800 MHz and/or any particular frequency band, but rather may be used with any frequency band communications as desired and/or suitable to the desired end purpose, such as RF frequency (AM, FM, Cellular frequency bands, etc), IR frequencies, visible frequencies and/or UV frequencies, NFC, Bluetooth/Bluetooth Low Energy, Wifi, Zigbee, Optical data transmission, or physical hardwired connection. Additionally, it is contemplated that the invention may be used with multiple frequency bands. Moreover, it should be further appreciated that one or more of the first interface device 102, 202, second interface device 104, 204 and/or the keypad interface 116 may be communicated with the television system 106, 206 and/or fitness device 108, 208 via a CSAFE port following CSAFE protocols. Additionally, it should be appreciated that in another embodiment, the first interface article 102, 202 and second interface article 104, 204 may be integrated into the same package so that one hardware device would be capable of functioning as the first interface article and the second interface article.

It should be appreciated that in another embodiment all or some of the elements of the communication interface system 100, 200 may be combined together and/or integrated into the fitness device 108, 208. For example, in one embodiment, the first interface article 102, 202, second interface article 104, 204 and/or keypad interface 116 may be combined into one device. In another embodiment, the first interface article 102, 202 may be integrated with the fitness device 108, 208. In still yet another embodiment, the second interface article 104, 204 may be integrated with the cable/satellite input box 114, 215. In still yet another embodiment, the first interface article 102, 202 and the second interface article 104, 204 (or the functionality of both) may be integrated into the fitness device 108, 208. Moreover, it is contemplated that the first interface article 102, 202 may be communicated with the fitness device 108, 208 and/or the television system 106, 206 via a hardwired connection and/or a wireless connection.

It should be appreciated that as referred to herein, the terminology ‘electrically connected’, ‘communicated with’, ‘in signal communication with’, and like terminology means that the systems, articles, and/or device are able to transmit signals and/or power to each other via a physical hard wire connection, fiber optic connection and/or a wireless connection.

In accordance with the present invention, the processing of the invention may be implemented, wholly or partially, by a controller operating in response to a machine-readable computer program. In order to perform the prescribed functions and desired processing, as well as the computations therefore (e.g. execution control algorithm(s), the control processes prescribed herein, and the like), the controller may include, but not be limited to, a processor(s), computer(s), memory, storage, register(s), timing, interrupt(s), communication interface(s), and input/output signal interface(s), as well as combination comprising at least one of the foregoing.

Moreover, the method of the present invention may be embodied in the form of a computer or controller implemented processes. The method of the invention may also be embodied in the form of computer program code containing instructions embodied in tangible media, such as floppy diskettes, CD-ROMs, hard drives, and/or any other computer-readable medium, wherein when the computer program code is loaded into and executed by a computer or controller, the computer or controller becomes an apparatus for practicing the invention. The invention can also be embodied in the form of computer program code, for example, whether stored in a storage medium, loaded into and/or executed by a computer or controller, or transmitted over some transmission medium, such as over electrical wiring or cabling, through fiber optics, or via electromagnetic radiation, wherein when the computer program code is loaded into and executed by a computer or a controller, the computer or controller becomes an apparatus for practicing the invention. When implemented on a general-purpose microprocessor the computer program code segments may configure the microprocessor to create specific logic circuits.

It should be appreciated that while the invention has been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Moreover, it is contemplated that elements of one embodiment may be combined with elements of other embodiments as desired. Therefore, it is intended that the invention not be limited to a particular embodiment disclosed herein as the best mode contemplated for carrying out this invention, but that the invention will include all embodiments (individually and/or combined) falling within the scope of the appended claims and/or information. Moreover, unless specifically stated any use of the terms first, second, etc. do not denote any order or importance, but rather the terms first, second, etc. are used to distinguish one element from another.

We claim:

1. A communication interface system for facilitating the communication between a television system and a cable/satellite set top box, the communication interface system comprising:
at least one interface article, wherein the at least one interface article is in signal communication with the television system and the cable/satellite set top box;
wherein the at least one interface article is configured to receive television control signals, identify channel control signals having television Remote Control (RC) codes from the television control signals, communicate with a handheld remote control configured to communicate with the cable/satellite set top box to receive and store cable/satellite box Remote Control (RC) codes, generate a processed signal responsive to the television RC codes containing cable/satellite box RC codes compatible with the cable/satellite set top box and transmit the processed signal to the cable/satellite set top box.

2. The communication interface system of claim 1, wherein the at least one interface article includes,
a first interface article in signal communication with the television system; and
a second interface article in signal communication with the first interface article and the cable/satellite set top box; and
wherein the second interface article is in signal communication with the first interface article via at least one of a hardwired connection and a wireless connection.

3. The communication interface system of claim 2, wherein the first interface article is further configured to identify volume control signals and power on/off signals from the television control signals and transmit at least one of the volume control signals and power on/off signals to the television system.

4. The communication interface system of claim 3, wherein the first interface article is configured to convert at least one of the volume control signals and power on/off signals to a serial protocol prior to transmitting the at least one of the volume control signals and power on/off signals to the television system.

5. The communication interface system of claim 1, wherein the television system includes a television monitor configured to display a video from a cable/satellite channel.

6. The communication interface system of claim 1, wherein the television system is associated with a fitness device and wherein at least one of the television system and fitness device includes television control buttons and wherein the television control buttons include at least one of a channel control button, a volume control button and/or a power control button.

7. The communication interface system of claim 6, wherein at least one of,
the television control buttons are integrated with at least one of the fitness device and the television monitor, and
the television system is integrated with the fitness device.

8. The communication interface system of claim 1, further comprising a keypad interface article, wherein the keypad interface article includes at least one of a channel control button, a volume control button and/or a power control button.

9. The communication interface system of claim 1, wherein the processed signal is compatible with the cable/satellite set top box.

10. The communication interface system of claim 1, wherein the at least one interface article is in signal communication with the cable/satellite set top box via at least one of a hardwired connection and a wireless connection.

11. The communication interface system of claim 1, wherein the at least one interface article is in signal communication with the television system via at least one of a hardwired connection and a wireless connection.

12. The communication interface system of claim 1, wherein the cable/satellite set top box includes a handheld remote control and wherein the at least one interface article is configured to wirelessly communicate with the handheld remote control.

13. The communication interface system of claim 1, wherein the at least one interface article is at least one of,
integrated with the fitness device,
integrated with the television system,
integrated with the cable/satellite set top box; and
a standalone unit.

14. A method for facilitating the communication between a cable/satellite set top box and at least one of a fitness device and a television system, wherein the television system includes a television monitor, the method comprising:
receiving television control signals, wherein the television control signals include at least one of a volume control signal, a power control signal and a channel control signal;
identifying whether the television control signals include at least one of the volume control signal, the power control signal and the channel control signal, wherein
if the television control signals include the channel control signal, processing the channel control signal and transmitting a processed channel control signal to the cable/satellite set top box; and
if the television control signals include at least one of the volume control signal and the power control signal, processing the at least one of the volume control signal and the power control signal and transmitting the at least one of the volume control signal and the power control signal to the television system.

15. The method claim 14, wherein receiving television control signals include receiving television control signals from at least one of a keypad interface and television control buttons, wherein the television control buttons are at least one of integrated with the fitness device and integrated with the television system.

16. The method of claim 14, wherein processing includes processing at least one of the volume control signals and power on/off signals to format the at least one of the volume control signals and power on/off signals to a serial protocol prior to transmitting the at least one of the volume control signals and power on/off signals to the television system.

17. The method of claim 14, wherein the cable/satellite set top box includes a handheld remote control and wherein the method further includes,
configuring the at least one interface article into a learning mode;
communicating with the at least one interface article with the handheld remote control such that the cable/satellite RC codes are received by the at least one interface article; and
storing the cable/satellite RC codes within the at least one interface article.

18. The method of claim 17, wherein processing includes processing the channel control signal to identify television Remote Control (RC) codes, and generating the processed channel control signal responsive to the television RC codes, wherein the processed channel control signal includes cable/satellite RC codes compatible with the cable/satellite set top box.

19. A communication interface system for facilitating the communication between a cable/satellite set top box and a fitness device having a television system, the communication interface system comprising:
at least one interface article, wherein the at least one interface article is in signal communication with at least one of the television system, the fitness device, a television control panel, a keypad interface article and the cable/satellite set top box; and
wherein the at least one interface article is configured to receive and process television control signals from at least one of the television system, the fitness device, the television control panel, and the keypad interface article, identify channel control signals having television Remote Control (RC) codes from the television control signals, communicate with a handheld remote control configured to communicate with the cable/satellite set top box to receive and store cable/satellite box Remote Control (RC) codes, generate a processed signal having the cable/satellite box RC codes responsive to the television RC codes and being configured to operate with the cable set top box and transmit the processed signal to the cable/satellite set top box.

20. The communication interface system of claim 19, wherein the television system is at least one of,
partially integrated with the fitness device,
fully integrated with the fitness device, and
externally connected to the fitness device.
